(19) United States
(12) Patent Application Publication
(10) Pub. No.: US 2002/0179398 A1
(43) Pub. Date: Dec. 5, 2002

(54) Diaphragm assist spring for motor vehicle engine clutch mechanism

(76) Inventors: Ayman Mokdad, Amiens (FR); Laurent Dequesnes, Fouilloy (FR)

Correspondence Address: Liniak Berenato, Longacre & White, Suite 240, 6550 Rock Spring Drive, Bethesda, MD, 20817, US

(21) Appl. No.: 10/089,603

(22) PCT Filed: Aug. 10, 2001
(86) PCT No.: PCT/FR01/02598

(30) Foreign Application Priority Data
Aug. 11, 2000 (FR) 0010615
May 28, 2001 (FR) 0106945

(51) Int. Cl. F16D 13/50

(52) U.S. Cl. 192/70.27; 192/89.23; 192/109 A

(57) ABSTRACT

A diaphragm clutch mechanism for a motor vehicle engine having a friction lining adapted to be clamped with an annular diaphragm between a reaction plate and a pressure plate. A cover fixed to the reaction plate and integral in rotation with the pressure plate which is also mobile in axial translation relative to the reaction plate, and an assist mechanism includes a Belleville washer which co-operates with the diaphragm so that the load exerted on the pressure plate should be substantially constant whatever the degree of wear of the friction lining when the clutch mechanism is in engaged position. The assist Belleville washer is supported on the diaphragm or on the cover that forms a front stop. The assist Belleville washer is supported on a rear stop borne by the cover so as to be slightly stressed when the clutch mechanism is in the released position.

This invention relates to a diaphragm clutch mechanism for a motor vehicle engine.

In general terms a diaphragm clutch mechanism comprises, in particular, at least one friction liner which is arranged to be gripped between a pressure plate and a reaction plate by an annular diaphragm which constitutes a clamping means.

The diaphragm is mounted pivotally on a cover plate which is fixed to the reaction plate, and the pressure plate is coupled in rotation with the cover plate but is movable in axial straight-line movement with respect to the cover plate. The radially outer part of the diaphragm bears on the pressure plate, while its radially inner part is in cooperation with a control member such as a clutch release bearing which is movable in axial straight line motion.

In addition, the characteristic curve of the diaphragm (of force as a function of deflection) has a generally sinusoidal form and passes through a maximum, as is described, in particular, in the document FR-A-2 456 877. The operating point varies over time, as a function of wear in the friction liner, and this results in a variation of the force which is applied by the diaphragm on the pressure plate.

Thus, when the friction liner starts to wear, the force applied by the diaphragm increases, as does the pressure force of the liner on the reaction plate. This results in an increase in the load on the clutch pedal.

In order to overcome this disadvantage, it is known to associate assistance means with the diaphragm, with the object that the force applied by the diaphragm will be substantially constant regardless of the degree of wear in the friction liner.

These assistance means have the function of applying an opposing force on the diaphragm according to a characteristic curve which, ideally, follows that of the diaphragm.

However, a solution of this kind is not simple to put into practice, because it must be possible to be able to locate the assistance means in an environment where there is only very limited space available.

In addition, the assistance system must, in all positions, be fitted without a clearance, that is to say with a prestress, in order to avoid noise and wear in the region of the contacts between the components.

One object of the invention is to design assistance means which can fulfil a function reliably and effectively on the one hand, and which can be fitted in a simple way and without modification of the arrangement of the clutch mechanism on the other hand.

To this end, the invention proposes a diaphragm clutch mechanism for a motor vehicle engine, the said mechanism including at least one friction liner which is adapted to be gripped by means of an annular diaphragm between a reaction plate and a pressure plate, a cover plate fixed to the reaction plate and coupled to the pressure plate for rotation with the latter while being also movable in axial straight line motion with respect to the reaction plate, and assistance means consisting of at least one Belleville ring which co-operates with the diaphragm so that the load exerted by the latter on the pressure plate is substantially constant regardless of the degree of wear in the friction liner when the clutch mechanism is in an engaged position, the clutch mechanism being characterised in that the Belleville assistance ring bears on the diaphragm or cover plate which constitutes a forward abutment, and in that the Belleville assistance ring bears on a rear abutment carried by the cover plate so as to be under slight stress at least when the clutch mechanism is in a disengaged position.

The clutch mechanism is preferably so designed that a slight opposing force is applied to the diaphragm when it is in a disengaged position with a new friction liner.

In general terms, the clutch mechanism makes use in particular of three components, namely the cover plate, the Belleville assistance ring and the diaphragm, and it includes two centring means selected from three possible means, namely means for centring as between the cover plate and diaphragm, between the diaphragm and the Belleville assistance ring, or between the cover plate and the Belleville assistance ring, whereby to have a statically determinate structure.

In a first embodiment, the Belleville assistance ring is fitted between the pressure plate and the cover plate, and the attachment means between the diaphragm and Belleville assistance ring consist of either external hooks which are carried by the assistance ring and which are closed, optionally with some clearance, around the periphery of the diaphragm, or external lugs which are bent back, and which are carried by the assistance ring and engage in notches formed at the periphery of the diaphragm.

In a second embodiment, the Belleville assistance ring is mounted on the outside of the cover plate, and the attachment means between the diaphragm and Belleville ring can be similar to those in the first embodiment.

With the first embodiment, it is possible in particular to form a sub-assembly consisting of the cover plate, diaphragm and Belleville assistance ring, in a simple and inexpensive way.

In addition, the two embodiments envisaged offer the major advantage that they can be fitted on standard mass-produced cover plates.

Further advantages, features and details of the invention will appear from the contents of the following description, given with reference to the attached drawings which are by way of example only, and in which:

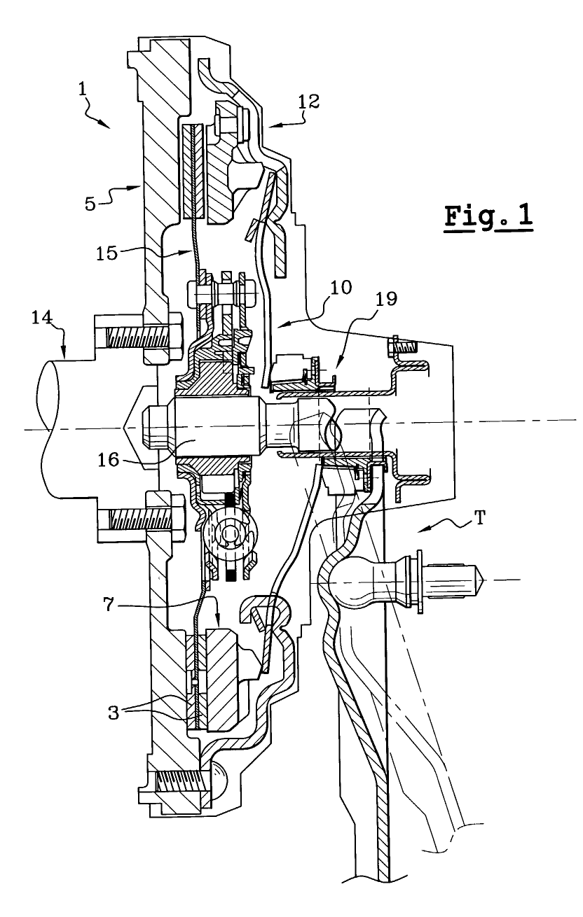

FIG. 1 is a diagrammatic view on axial cross section of a conventional diaphragm clutch mechanism which is known per se,

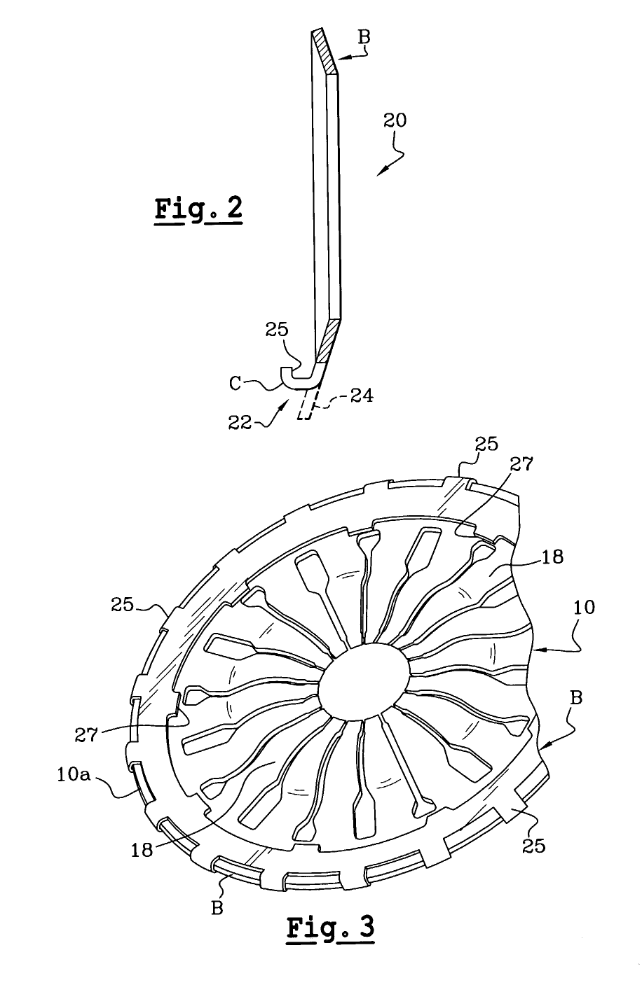

FIG. 2 is a view in diametral cross section of a Belleville ring which constitutes assistance means according to the invention, and which co-operates with the diaphragm of the clutch mechanism of FIG. 1,

FIG. 3 is a diagrammatic perspective view of the diaphragm and Belleville ring, attached to each other before being fitted in the clutch mechanism, in a first embodiment of the invention,

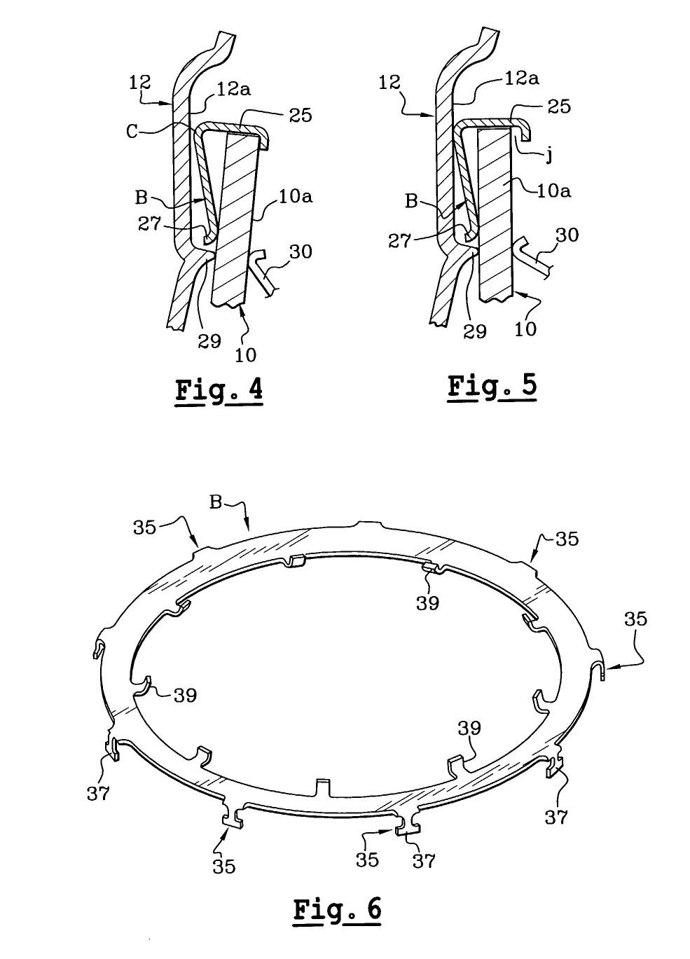

FIG. 4 is a partial, diagrammatic view in cross section showing the diaphragm and Belleville ring once they have been fitted in the clutch mechanism and in the engaged position of the latter,

FIG. 5 is a view in cross section similar to that in FIG. 4, but in the disengaged position of the clutch mechanism, and

FIG. 6 is a perspective view of a Belleville ring in another version of the first embodiment of the invention,

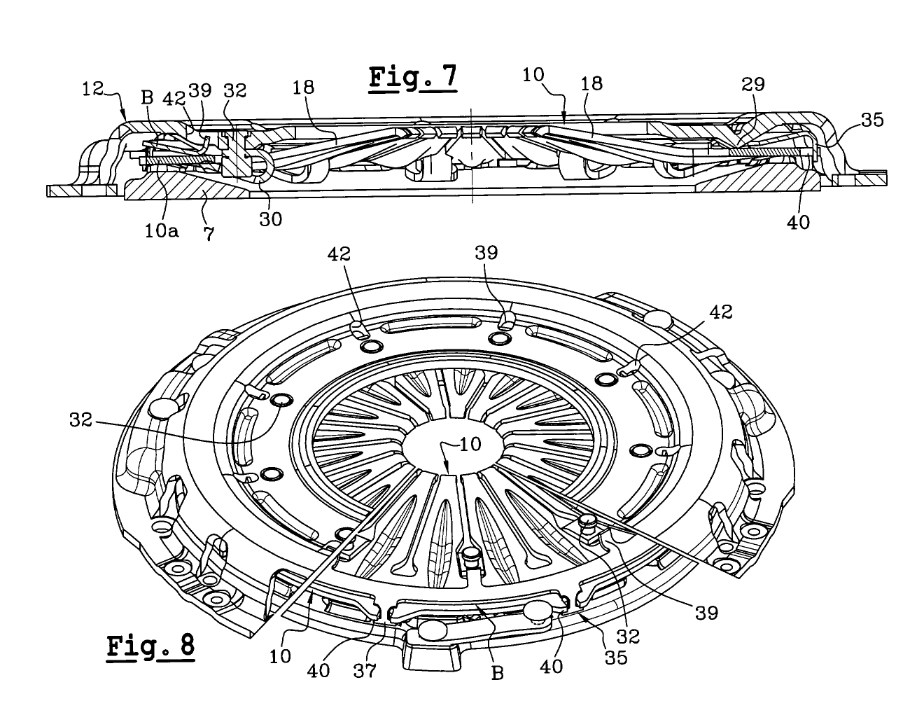

FIG. 7 is a partial, diagrammatic view in cross section showing the Belleville ring of FIG. 6 and the diaphragm once they have been attached or assembled together,

FIG. 8 is a version of FIG. 7 shown in perspective,

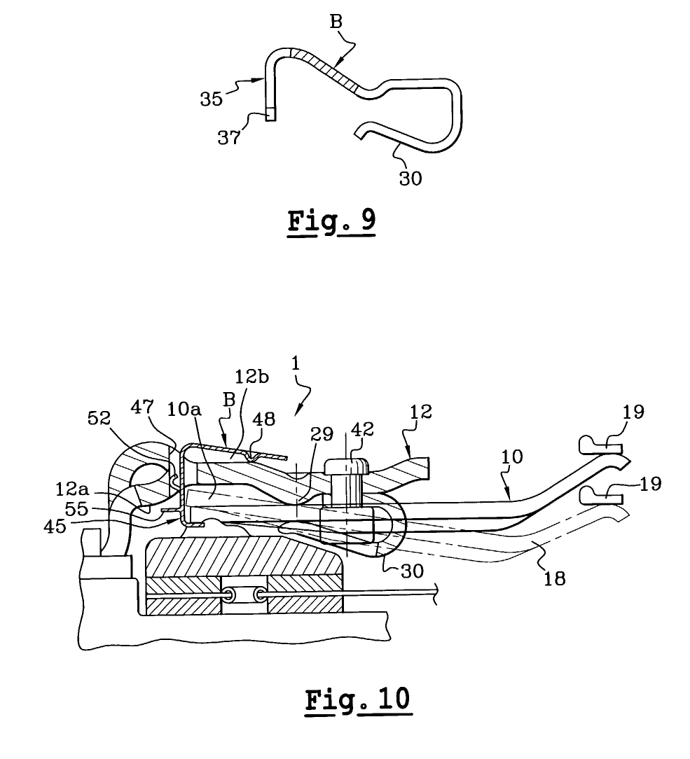

FIG. 9 is a detail view of a further version of the first embodiment,

FIG. 10 is a partial and diagrammatic view in cross section to show the principle of a second embodiment of the invention,

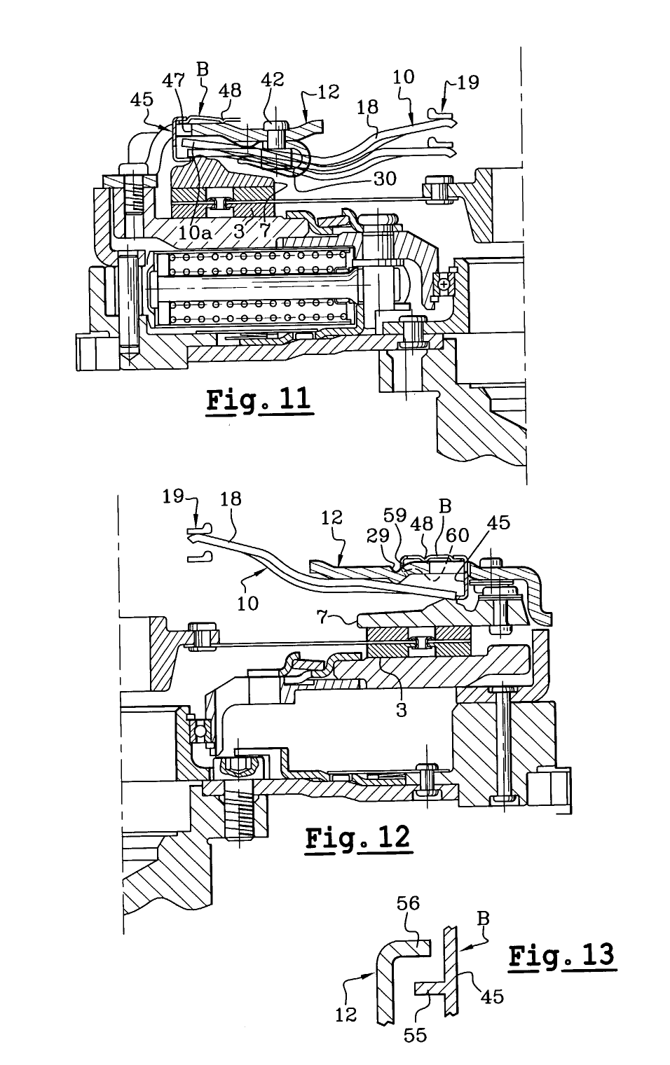

FIGS. 11 and 12 are two partial and diagrammatic views in cross section to illustrate two examples of the second embodiment illustrated in FIG. 9,

FIG. 13 is a detailed view to show a rear abutment for the Belleville assistance ring,

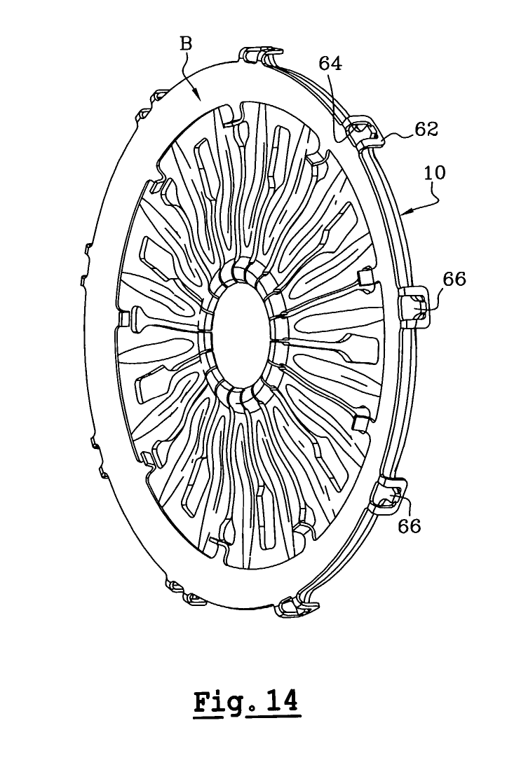

FIG. 14 is a perspective view of the diaphragm and Belleville ring attached to each other by means which constitute another version of the first embodiment of the invention,

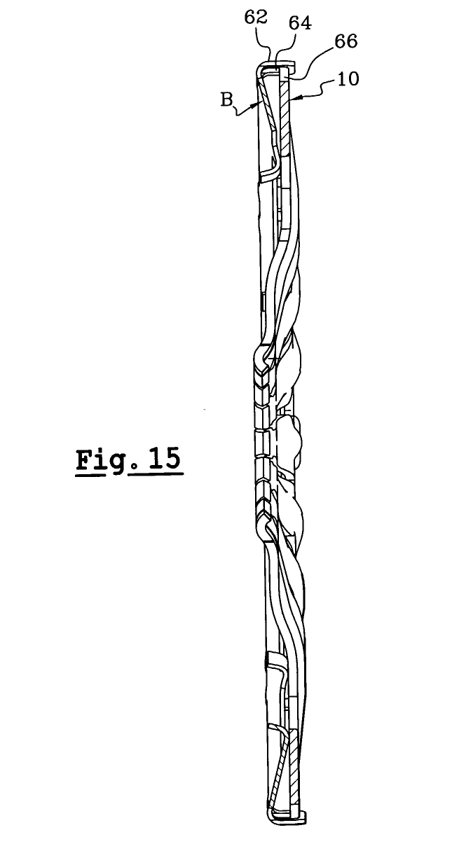

FIG. 15 is a view in diametral cross section of the diaphragm and Belleville ring shown in FIG. 14,

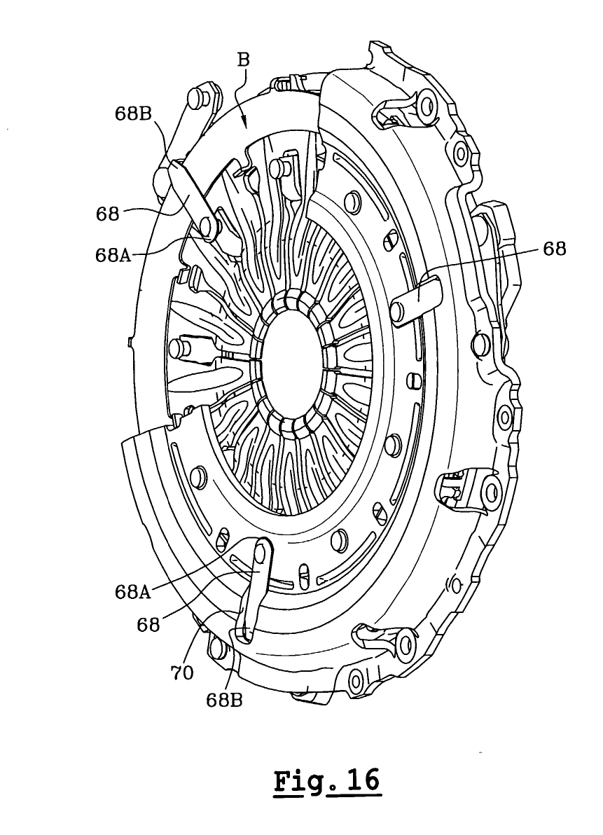

FIG. 16 is a perspective view similar to FIG. 8, showing a third embodiment of the invention,

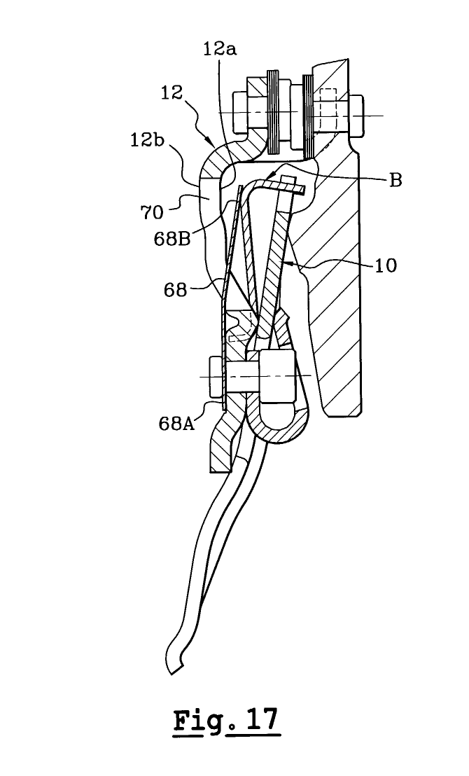

FIG. 17 is a view in radial cross section of the diaphragm and Belleville ring shown in FIG. 16, and

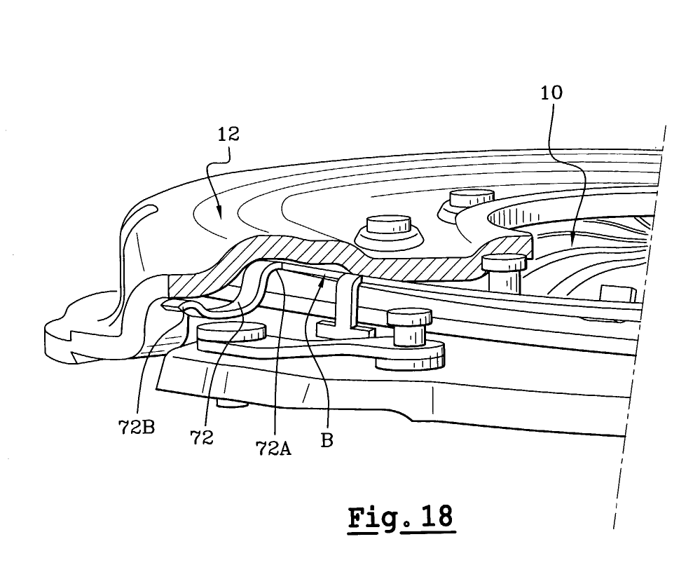

FIGS. 18 to 20 are perspective views which show, respectively, three further versions of the Belleville ring in the third embodiment of the invention.

The diaphragm clutch mechanism 1 shown in FIG. 1 comprises, in a manner known per se, at least one friction liner 3 which is arranged to be gripped between a reaction plate 5 and a pressure plate 7, by means of an annular diaphragm 10.

The clutch mechanism 1 also includes a cover plate 12 which is fixed on the reaction plate 5, whereas the pressure plate 7 is fixed to the cover plate 12 for rotation with the latter and is movable in axial straight line movement with respect to the reaction plate 5.

The reaction plate 5 is fixed to a driving shaft 14 for rotation with the latter, while the liner 3 is carried by a disc 15 fixed to a driven shaft 16 for rotation with the driven shaft, which is for example the input shaft of the gearbox.

The diaphragm 10 is mounted for pivoting movement on the cover plate 12 so that its radially outermost, or peripheral, portion 10a can engage on the pressure plate 7, while its radially innermost portion, which is divided into a plurality of rigid radial fingers 18, co-operates with a control member 19 such as a clutch release bearing which is movable axially and actuated by a linkage T, which may for example be of a mechanical type.

When the clutch is in an engaged position, the friction liner 3 is gripped between the reaction plate 5 and pressure plate 7 by virtue of the force exerted by the diaphragm 10. This force is such that the friction disc 15 is driven in rotation so that the driven shaft 16 is coupled in rotation with the driving shaft 14.

On the other hand, when the clutch release bearing 19 is operated, it performs a so-called declutching travel, bearing on the radially internal fingers 18 of the diaphragm 10 so as to apply to the latter a force such that it releases its action on the pressure plate 7, thereby uncoupling the friction disc 15 from rotation with the pressure plate 7 and reaction plate 5, that is to say the driven shaft 16 is no longer coupled in rotation to the driving shaft 14.

For the reasons explained in the preamble, wear in the liner 3 on the one hand, and the characteristic force-deflection curve of the diaphragm 10 on the other hand, are such that it is of advantage to provide assistance means 20 such that the force applied by the diaphragm 10 on the pressure plate 7 will be substantially constant irrespective of the degree of wear in the liner 3.

In general terms, and as is illustrated diagrammatically in FIG. 2, the assistance means 20 consist of a Belleville ring B which is connected to the diaphragm 10 by particular connection means 22 which perform two functions, namely a holding function and a driving function.

In general terms the Belleville ring B can be mounted either between the pressure plate 7 and cover plate 12, that is to say on the inner side of the cover plate, or else on the outside of the cover plate 12; accordingly, two types of assembly may be envisaged with appropriate connecting means 22.

A first embodiment is shown in FIGS. 2 to 5, with the first type of assembly in which the Belleville ring B is situated on the inner side of the cover plate 12.

The connecting means 22 shown in FIG. 2 consist of radially external lugs 24 carried by the Belleville ring B and extending beyond its major base, being spaced apart at regular intervals about this major base. These external lugs 24 are arranged to be bent back so as to form hooks 25 for the purpose of coupling with the diaphragm 10. With reference to FIG. 3, the Belleville ring B is applied against one face of the diaphragm 10, and its external lugs 24 are then bent back to form the hooks 25 which surround the perimeter of the diaphragm 10, being closed towards the other face of the diaphragm.

In addition, the Belleville ring B may have radially internal lugs 27 which are curved back to form points of engagement on the diaphragm 10, these internal lugs 27 being spaced apart at regular intervals around the ring B.

In a manner known per se, the diaphragm 10 is applied pivotingly to the cover plate 12 so that its peripheral portion 10a acts in the manner of a Belleville ring when the diaphragm 10 deforms. To this end, the diaphragm 10 bears on an annular bead 29 projecting from the internal wall of the cover plate 12, and on the ends of a plurality of elastic lugs 30 which are fixed with respect to the cover plate 12, for example by means of rivets 32, these two points of engagement being situated on either side of the diaphragm 10 and generally constituting an elastic articulation.

In general terms, the bead 29 on which the diaphragm 10 bears may be discontinuous, so that the points of engagement of the internal lugs 27 of the Belleville ring B can be situated at substantially the same level as the engagement bead 29.

The Belleville ring B is mounted coaxially with the diaphragm 10 so that it lies facing the peripheral portion 10a that constitutes the Belleville ring, and in such a way that, as is shown in FIG. 4:

the internal lugs 27 bear on the diaphragm 10 which constitutes a forward abutment,

the bends C of the hooks 25 do not engage on the inner wall 12a of the cover plate 12, which constitutes a rear abutment, and

the hooks 25 of the Belleville ring B are closed around the diaphragm 10.

In FIG. 4, the clutch mechanism 1 is taken to be in a position in which the clutch is engaged and in which the diaphragm 10 applies a force on the pressure plate 7 sufficiently large for the driving shaft 14 and driven shaft 16 to be coupled together in rotation.

In general terms, the initial deformation or deflection of the diaphragm 10, that is to say its axial compression, is such that the force applied on the pressure plate 7 satisfies a value which is predetermined and calculated for a friction liner 3 in the new state and having a certain thickness.

Under these conditions it would not be necessary that the assistance means 20 act positively on the diaphragm 10 so long as no wear has appeared in the friction liner 3.

However, in accordance with the invention, the assistance means 20 may be adjusted in such a way that a slight opposing force is applied on the diaphragm 10. This adjustment corresponds to the state shown in FIG. 4, in which the diaphragm 10 slightly biases the Belleville ring B by pulling on its outer rim by means of the hooks 25 which constitute a driving means.

As the friction liner 3 becomes worn, the diaphragm 10 acts more and more on the Belleville ring B by pulling on the hooks 25, so that the resulting force applied on the pressure plate 7 is substantially constant and independent of the degree of wear in the liner 3 and the course of deformation of the diaphragm 10.

On the other hand, as is shown in FIG. 5, when the clutch release bearing 19 is actuated by the linkage T so as to shift the clutch mechanism 1 into its declutched position, the diaphragm 10 progressively releases its pressure, the Belleville ring B reverts to engagement on the cover plate 12 at the level of the bends in the hooks 25, and the diaphragm 10 is no longer in contact with the hooks 25 of the ring B, so that a clearance j appears between them.

It is important to note that as it deforms, the diaphragm 10 leaves the Belleville ring B in engagement on the rear abutment defined by the cover plate 12, so as to keep it slightly under stress and prevent it from being subjected to vibrations which could be a source of noise.

In the engaged position of the clutch when new, another solution whereby the Belleville ring B is mounted with a slight stress is to put it into engagement on the cover plate in the region of the bends in the hooks 25. In this case, the hooks 25 are close to the diaphragm 10 so that they can come into action after wear has started in the friction liner.

Another version of the first embodiment is shown in FIGS. 6 to 8, still with the first type of assembly in which the Belleville ring B is situated on the inner side of the cover plate 12.

The connecting means 22 between the Belleville ring B and diaphragm 10 consist of radially external lugs 35 which are situated at the periphery of the Belleville ring B and are spaced apart regularly around the latter, but they do not form hooks that are bent back around the diaphragm 10.

As is shown in FIG. 6, each external lug 35 is bent back substantially at 90° and is terminated in a T form to constitute at its end a driving foot 37. On the internal side, the Belleville ring B has internal lugs 39 which are bent back in the opposite direction from the external portions 35, and which are spaced apart at regular intervals around the ring B. As will be seen later herein, the radially internal lugs 39 have a function of engagement on the diaphragm 10 on the one hand, and a function of centring the Belleville ring B with respect to the cover plate 12 on the other hand.

Assembly of the Belleville ring B on the diaphragm 10 can be carried out in two fitting operations.

In a first fitting operation which is of the clipping type, the Belleville ring B is applied against one face of the diaphragm 10 so that its external lugs 35 are put in facing relationship with notches 40 formed at the periphery of the diaphragm 10, and are then moved outwards before being reintroduced by elastic deformation into the interior of the notches 40, so that the driving feet 37 are situated at the level of the other face of the diaphragm. In other words, the depth of the bent-back part of each external lug 35 between the bend of the lug and the driving foot 37 is slightly greater than the thickness of the diaphragm 10.

In a second fitting operation, which is of the bayonet type, the Belleville ring B is still applied against one face of the diaphragm 10, but the external lugs 35 are offset angularly with respect to their respective receiving notches 40. Relative rotation between the Belleville ring B and diaphragm 10 then enables the lugs 35 to be able to penetrate into their respective notches 40.

Once the Belleville ring B has been assembled to the diaphragm 10, it should be noted that the internal lugs 39 of the Belleville ring B are caused to lie freely within oblong apertures 42 in the cover plate 12, while the bends C of the said internal lugs 39 bear on the diaphragm 10. These centring apertures 42 also enable the internal lugs 39 to shift when the Belleville ring B is deformed.

FIGS. 7 and 8 show the diaphragm 10 and Belleville ring B once they have been assembled together, the clutch mechanism 1 being supposed to be in its clutch engaged position.

When the clutch mechanism 1 is in a clutch engaged position, the diaphragm 10 draws slightly on the Belleville ring B in such a way that a slight opposing force is applied on the diaphragm 10. On the other hand, when the clutch mechanism 1 is in a disengaged position, the diaphragm 10 no longer draws on the Belleville ring B, but the latter will become engaged on the internal wall of the cover plate 12, which constitutes a rear abutment to hold the Belleville ring B under slight stress and prevent it from vibrating, given that it is always in engagement on the diaphragm 10 through its internal lugs 39.

In general terms, the assistance means bring three main components into use, namely: the diaphragm 10, the cover plate 12 and the Belleville ring B, given that it is possible to centre the cover plate 12 with respect to the Belleville ring B, the diaphragm 10 with respect to the Belleville ring B, and the cover plate with respect to the diaphragm. Three centring means are therefore possible, given that two of these three means are necessary in order to give a statically determinate structure. If all three centring means were used, the result would be a redundant structure, giving rise to additional stresses.

In the embodiment shown in FIGS. 6 to 8, the first centring means for the cover plate 12 with respect to the Belleville ring B are used, and consist of the internal lugs 39 which are engaged in the apertures 42 in the cover plate, together with second means for centring the cover plate 12 with respect to the diaphragm 10, consisting of the points of articulation of the diaphragm 10 that are fixed to the cover plate 12.

Another version of the first embodiment is illustrated diagrammatically in FIG. 9. In this version, the Belleville ring B incorporates the elastic lugs 30 which constitute a part of the means for articulating the diaphragm 10, these lugs 30 being fixed to the cover plate 12 as well, by means not shown.

A second embodiment is shown in FIGS. 10 to 13, using the second type of mounting in which the Belleville ring B is situated on the outside of the cover plate 12.

In general terms, the connecting means 22 between the Belleville ring B and diaphragm 10 consist of radially external lugs defining hooks 45 which extend through apertures 47 formed in the cover plate 12, so as to be closed around the periphery of the diaphragm 10 as shown in FIG. 10, which is a diagram illustrating the principle.

Towards its minor base, the Belleville ring B bears through a bead 48 on the outer wall 12b of the cover plate 12, which constitutes a forward abutment. Some of the hooks 45 have an external retaining finger 52 which is situated at the level of the passage apertures 47 in the cover plate 12. The function of these fingers 52 is to bear on the wall of the apertures 47, so as to prevent the hooks 45 from being able to open under the action of the centrifugal force which is due to the high speed of rotation of the cover plate 12.

In addition, the Belleville ring B may be assembled to the diaphragm 10 in two fitting stages which are illustrated in FIGS. 11 and 12 respectively.

In the fitting operation shown in FIG. 11, the Belleville ring B is applied from the outside on the cover plate 12, and the external lugs formed by the hooks 45 are then attached so as to fix them to the peripheral portion of the Belleville ring B, the hooks 45 passing through the apertures 52 in the cover plate and surrounding the peripheral portion of the diaphragm 10. The fastening means may be of the clipping type with circumferential locating means, or a fitting of the bayonet type.

In the fitting operation in FIG. 12, the Belleville ring is again applied on the cover plate 12 from outside. In this case, the hooks 45 constitute an annular crown with an L-shaped cross section, which is applied to the cover plate from the inside and is then fastened to the Belleville ring B by clipping or by a bayonet type fitting.

In the cases shown in FIGS. 10 to 12, the forward abutment is provided by the outer wall 12b of the cover plate 12, or is fixed with respect to this outer wall 12b, while the rear abutment, on which the Belleville assistance ring B bears when the clutch mechanism 1 is in a declutched position, consists of the internal wall 12a of the cover plate 12 or is fixed with respect to this internal wall 12a.

Thus in FIG. 10, it can be seen that the Belleville assistance ring B is provided with radially external lugs 55 which are in cooperation with the rear abutment of the cover plate 12 that consists of the internal wall 12a of the cover plate 12.

In FIG. 13 it can be seen that, in order to maintain the Belleville ring B under a slight stress when the clutch mechanism 1 is in a declutched position, the radially external lugs 55 carried by the Belleville ring B are arranged to engage on abutments 56 carried by the cover plate 12.

The Belleville ring B also carries second radially inner lugs 59 (FIG. 12), which penetrate into apertures 60 in the cover plate 12, and the function of which is to centre the Belleville ring B with respect to the cover plate 12. Second means for centring the diaphragm 10 with respect to the cover plate 12 consist of the points of articulation of the diaphragm 10 which are fixed to the cover plate 12.

In another version of this second embodiment, the hooks 45 that constitute the attachment means between the diaphragm 10 and the Belleville assistance ring B may be replaced by lugs 35 terminated by driving feet 37, as shown in FIG. 6 for the first embodiment.

Finally, as in the first embodiment, at least two centring means are provided, among the three possible means for centring between cover plate, diaphragm and Belleville assistance ring. In this second embodiment, there are first centring means between the Belleville assistance ring B and the cover plate 12 which consist of the internal lugs 59 that engage in the apertures 60 in the cover plate, together with second centring means between the diaphragm 10 and the cover plate which consist of the points of articulation of the diaphragm 10 to the cover plate 12.

FIGS. 14 and 15 show a diaphragm 10 and a Belleville assistance ring B attached to each other by means which constitute another version of the first embodiment of the invention.

These attachment means comprise substantially axial extensions 62 of the Belleville assistance ring B, in each of which an eyelet 64 is formed.

The eyelets 64 are spaced apart over the periphery of the Belleville assistance ring B, and constitute seatings for radial lugs 66 which extend the periphery of the diaphragm 10.

The extensions 62 in which the eyelets 64 are formed constitute relatively rigid closed loops which are hardly deformed during the heat treatment of the Belleville ring B. In addition, the lugs 66 are joined to the rest of the diaphragm 10 through contoured portions of relatively large radius, thereby substantially reducing the stresses in the region of the connection between the diaphragm 10 and lugs 66.

FIGS. 16 and 17 show the main elements of a clutch mechanism in a third embodiment of the invention.

In this case, the Belleville assistance ring B bears on the rear abutment carried by the cover plate 12 regardless of the position of the clutch mechanism 1.

In the example shown in FIGS. 16 and 17, the Belleville assistance ring B bears on the rear abutment through abutment elements which connect the Belleville ring B to the cover plate 12. These abutment elements, of which there are preferably three, are spaced apart circumferentially on the periphery of the Belleville ring B.

Each abutment element consists of an elastic tongue 68 having an end 68A which is fixed by conventional means on the cover plate 12, with a free end 68B which is in elastic engagement on the Belleville assistance ring B.

It will be noted with reference to FIG. 17 that each elastic tongue 68 extends through an aperture 70 in the cover plate 12, between the internal wall 12a and external wall 12b of this cover plate.

Thus, whatever the position of the clutch mechanism 1, engaged or disengaged, the Belleville assistance ring B bears on the elastic tongues 68 constituting the rear abutment carried by the cover plate 12. The elastic tongues 68 accordingly maintain a slight stress on the Belleville ring B in all positions of the clutch mechanism (engaged or disengaged), so as to prevent the Belleville ring from being subjected to vibrations liable to be a source of noise, especially during the shift from an engaged to a disengaged position of the mechanism.

FIGS. 18 to 20 show other versions of the Belleville ring B in the third embodiment of the invention.

In these versions, the abutment elements are integral with the Belleville assistance ring B.

In the version shown in FIG. 18, each abutment element comprises a lug which constitutes an external extension 72 of the Belleville assistance ring B. This external extension 72 is provided with an end 72A by which it is connected with the Belleville ring B, and a free end 72B in elastic engagement on the rear abutment constituted by the internal wall of the cover plate 12.

It will be noted that the free end 72B is substantially aligned radially with the connecting end 72A.

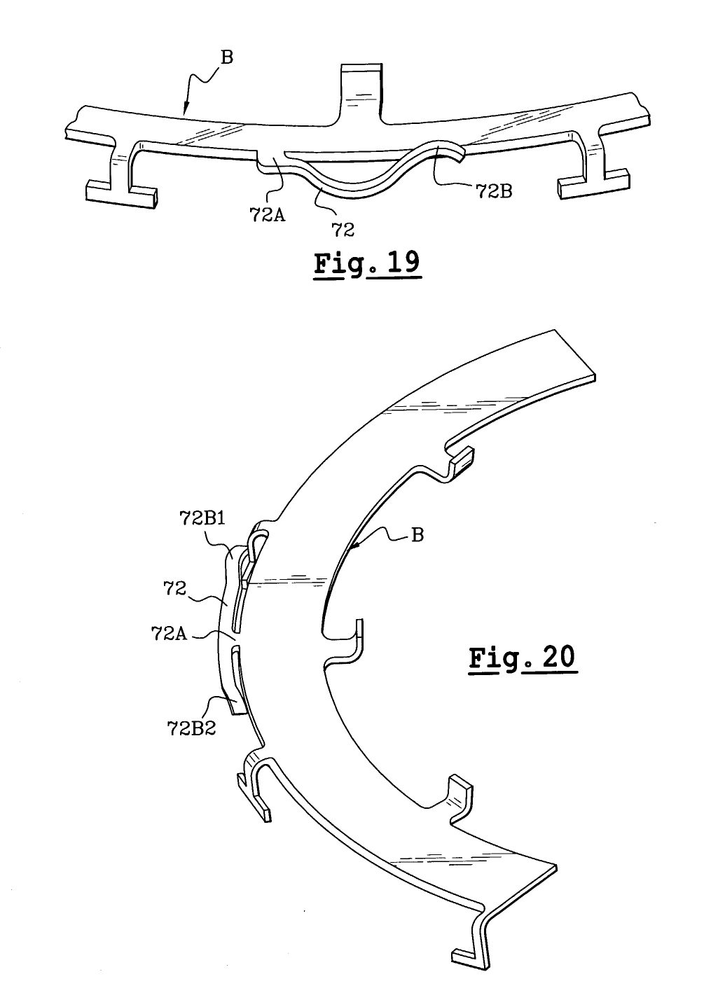

In the version shown in FIG. 19, the external extension 72 includes a free end 72B which is offset circumferentially with respect to the connecting end 72A.

In the version shown in FIG. 20, the external extension 72 is generally T-shaped, and has two free ends 72B1, 72B2, which are offset circumferentially in opposite directions, with respect to the connecting end 72A.

The invention is applicable to clutch mechanisms of the pull-to-release or push-to-release type, whether governed or not.

1. A diaphragm clutch mechanism for a motor vehicle engine, the said mechanism (1) including at least one friction liner (3) which is adapted to be gripped by means of an annular diaphragm (10) between a reaction plate (5) and a pressure plate (7), a cover plate (12) fixed to the reaction plate (5) and coupled to the pressure plate (7) for rotation with the latter while being also movable in axial straight line motion with respect to the reaction plate (5), and assistance means (20) consisting of at least one Belleville ring (B) which co-operates with the diaphragm (10) so that the load exerted by the latter on the pressure plate (7) is substantially constant regardless of the degree of wear in the friction liner (3) when the clutch mechanism (1) is in an engaged position, characterised in that the Belleville assistance ring (B) bears on the diaphragm (10) or cover plate (12) which constitutes a forward abutment, and in that the Belleville assistance ring (B) bears on a rear abutment carried by the cover plate (12) so as to be under stress at least when the clutch mechanism (1) is in a disengaged position.

2. A diaphragm clutch mechanism according to claim 1, characterised in that, when the clutch mechanism (1) is in an engaged position with a new friction liner (3), the Belleville assistance ring (B) applies a light or zero force on the diaphragm (10).

3. A diaphragm clutch mechanism according to claim 1 or claim 2, characterised in that, when the clutch mechanism (1) is in a disengaged position, the Belleville assistance ring (B) applies no force on the diaphragm (10).

4. A clutch mechanism according to any one of the preceding claims, characterised in that it includes two centring means selected from three possible centring means, namely means for centring as between the cover plate (12) and diaphragm (10), or between the diaphragm (10) and the Belleville assistance ring (B), or between the cover plate (12) and the Belleville assistance ring (B).

5. A diaphragm clutch mechanism according to any one of the preceding claims, characterised in that the Belleville assistance ring (B) is mounted between the pressure plate (7) and the cover plate (12), and in that the Belleville assistance ring (B) has radially external lugs (24) which are bent back to define hooks (25) that surround the peripheral portion (10a) of the diaphragm with a clearance when the clutch mechanism (1) is in a disengaged position.

6. A diaphragm clutch mechanism according to claim 5, characterised in that the Belleville assistance ring (B) is mounted between the pressure plate (7) and the diaphragm (10).

7. A diaphragm clutch mechanism according to any one of the preceding claims, characterised in that the Belleville assistance ring (B) is mounted on the outside of the cover plate (12), in that it includes radially external lugs defining hooks (45) that extend through apertures (47) formed through the cover plate, so as to come into engagement with the diaphragm (10), and in that the Belleville assistance ring (B) engages on the external wall of the cover plate (12) through an abutment bead (48).

8. A diaphragm clutch mechanism according to claims 5 to 7, characterised in that the Belleville assistance ring (B) is frustoconical in form with a minor base and a major base, in that the minor base is in permanent abutment on the diaphragm (10) at points situated in the vicinity of the points of articulation of the diaphragm (10), and in that the major base bears on the internal wall of the cover plate (12) when the clutch mechanism is in a disengaged position.

9. A diaphragm clutch mechanism according to claim 8, characterised in that the points of articulation of the diaphragm (10) which enable its peripheral portion (10a) to constitute a Belleville ring (B) consist of a bead (29) projecting from the internal wall of the cover plate (12), together with elastic lugs (30) fixed with respect to the cover plate (12), the said points of articulation being situated on either side of the cover plate (12).

10. A diaphragm clutch mechanism according to any one of claims 1 to 3, characterised in that the Belleville assistance ring (B) is mounted between the pressure plate (7) and cover plate (12), in that the Belleville assistance ring (B) includes radially external lugs (35) which are bent back at substantially 90° and each of which terminates in a driving foot (37), and in that the said external lugs (35) are adapted to be lodged within notches (40) formed at the periphery of the diaphragm (10).

11. A diaphragm clutch mechanism according to claim 10, characterised in that the external lugs (35) of the Belleville assistance ring (B) terminate in a T-shaped end, the base of the T constituting the driving foot (37).

12. A diaphragm clutch mechanism according to claim 10 or claim 11, characterised in that the external lugs (35) of the Belleville assistance ring (B) are fitted by elastic deformation within notches (40) of the diaphragm (10).

13. A diaphragm clutch mechanism according to claim 12, characterised in that the external lugs (35) of the Belleville assistance ring (B) are engaged in notches (40) of the diaphragm (10) after relative rotation between the Belleville assistance ring (B) and diaphragm (10).

14. A diaphragm clutch mechanism according to any one of claims 10 to 13, characterised in that the Belleville assistance ring (B) includes radially internal lugs (39) which are bent back outwards in a direction away from that of the radially external lugs (35), and in that the said internal lugs (39) are engaged freely within oblong radial apertures (42) formed through the cover plate (12), with the said internal lugs (39) centring the Belleville assistance ring (B) with respect to the cover plate.

15. A diaphragm clutch mechanism according to claim 14, characterised in that the diaphragm (10) is centred with respect to the cover plate (12) by means of articulation lugs (30) of the diaphragm (10) which are fixed to the cover plate (12) on the one hand, and an abutment bead (29) of the cover plate (12) on the other hand.

16. A diaphragm clutch mechanism according to claim 7, characterised in that the hooks (45) adapted to be bent back about the peripheral portion of the diaphragm (10) define a clearance when the clutch mechanism (1) is in a disengaged position.

17. A diaphragm clutch mechanism according to claim 7, characterised in that it includes retaining means for preventing the hooks (45) of the Belleville assistance ring (B) from opening under the effect of centrifugal force cue to rotation of the cover plate (12).

18. A diaphragm clutch mechanism according to claim 17, characterised in that the said retaining means consist of external fingers (52) which are supported by the hooks (45) of the Belleville assistance ring (B), and which come into engagement on the internal wall of the apertures (47) and the cover plate (12) through which the hooks (45) pass.

19. A diaphragm clutch mechanism according to any one of claims 16 to 18, characterised in that the forward abutment consists of an external wall of the cover plate (12), or is fixed to the said external wall, and in that the rear abutment on which the Belleville assistance ring (B) bears when the clutch mechanism (1) is in a disengaged position, consists of an internal wall of the cover plate (12) or is fixed with respect to the said internal wall.

20. A diaphragm clutch mechanism according to claim 19, characterised in that the Belleville assistance ring (B) is provided with radially external lugs (55) which are in cooperation with the rear abutment of the cover plate (12).

21. A diaphragm clutch mechanism according to any one of claims 16 to 20, characterised in that it includes means for centring the Belleville assistance ring (B) and cover plate (12), the said means consisting of radially internal lugs (59) of the Belleville assistance ring (B), the said lugs (59) being bent back so as to penetrate freely into apertures (60) in the cover plate (12).

22. A diaphragm clutch mechanism according to any one of claims 1 to 4, characterised in that the Belleville assistance ring (B) is provided with eyelets (64) spaced apart over its periphery and constituting seatings for radial lugs (66) which are extensions of the periphery of the diaphragm (10).

23. A diaphragm clutch mechanism according to claim 22, characterised in that each of the eyelets (64) is formed in a substantially axial extension (62) of the Belleville assistance ring (B).

24. A diaphragm clutch mechanism according to any one of the preceding claims, characterised in that the Belleville assistance ring (B) bears on the rear abutment carried by the cover plate (12) regardless of the position of the clutch mechanism (1).

25. A diaphragm clutch mechanism according to claim 24, characterised in that the Belleville assistance ring (B) bears on the rear abutment through abutment elements (68; 72) which couple the Belleville assistance ring (B) with the cover plate (12).

26. A diaphragm clutch mechanism according to claim 25, characterised in that each abutment element comprises an elastic tongue (68) having one end (68A) fixed on the cover plate (12) and a free end (68B) in elastic engagement on the Belleville assistance ring (B).

27. A diaphragm clutch mechanism according to claim 26, characterised in that the elastic tongues (68) extend through an aperture (70) in the cover plate (12), between an external wall (12b) and an internal wall (12a) of the cover plate (12).

28. A diaphragm clutch mechanism according to claim 25, characterised in that the abutment elements (72) are formed integrally with the Belleville assistance ring (B).

29. A diaphragm clutch mechanism according to claim 28, characterised in that each of the abutment elements comprises a lug constituting an external extension (72) of the Belleville assistance ring (B), having an end (72A) connecting it with the Belleville assistance ring (B) and at least one free end (72B) in elastic engagement on the Belleville assistance ring (B).

30. A diaphragm clutch mechanism according to claim 29, characterised in that the external extension (72) has a free end (72B) which is substantially in radial alignment with the connecting end (72A).

31. A diaphragm clutch mechanism according to claim 29, characterised in that the external extension (72) has a free end (72B) offset circumferentially radially with respect to the connecting end (72A).

32. A diaphragm clutch mechanism according to claim 29, characterised in that the external extension (72) is generally T-shaped and has two free ends (72B1, 72B2) which are offset circumferentially in opposite directions with respect to the connecting end (72A).
